(19) United States
(12) Patent Application Publication
(10) Pub. No.: US 2020/0063709 A1
(43) Pub. Date: Feb. 27, 2020

(54) Rotor Blade Assembly Having Twist, Chord, and Thickness Distribution for Improved Performance

(71) Applicant: General Electric Company, Schenectady, NY (US)

(72) Inventors: Christian Carroll, Simpsonville, SC (US); Stefan Herr, Greenville, SC (US)

(21) Appl. No.: 16/106,434

(22) Filed: Aug. 21, 2018

(51) Int. Cl. F03D 1/06

(52) U.S. Cl. CPC F03D 1/0633; F05B 2230/50; F05B 2240/221; F05B 2240/30; F05B 2260/96

(57) ABSTRACT

A rotor blade assembly of a wind turbine includes an aerodynamic body having an inboard region and an outboard region. The inboard and outboard regions define a pressure side, a suction side, a leading edge, and a trailing edge. The inboard region includes a blade root, whereas the outboard region includes a blade tip. The outboard region also has a twist variation of less than plus or minus about 0.5 degrees (°) in order to reduce a rate of reduction in at least one of a chord length or a thickness of the rotor blade in the outboard region.

### FIELD

The present disclosure relates in general to wind turbine rotor blades, and more particularly to rotor blades having twist, chord, and/or thickness distribution designed for improved noise performance, reduced loads, high efficiency, and/or improved ability to transport.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known airfoil principles. The rotor blades transmit the kinetic energy in the form of rotational energy so as to turn a main shaft coupling the rotor blades to a gearbox, or if a gearbox is not used, directly to the generator. More specifically, the rotor blades have a cross-sectional profile of an airfoil such that, during operation, air flows over the blade producing a pressure difference between the sides. Consequently, a lift force, which is directed from a pressure side towards a suction side, acts on the rotor blade. The lift force generates torque on the main shaft, which is geared to the generator for producing electricity. The generator then converts the mechanical energy to electrical energy that may be deployed to a utility grid.

The lift force is generated when the flow from the leading edge to the trailing edge creates a pressure difference between the top and bottom surfaces of the rotor blade. Ideally, the flow is attached to both the top and bottom surfaces from the leading edge to the trailing edge. However, when the angle of attack of the flow exceeds a certain critical angle, the flow does not reach the trailing edge, but leaves the surface at a flow separation line. Beyond this line, the flow direction is generally reversed, i.e. it flows from the trailing edge backward to the separation line. A blade section extracts much less energy from the flow when it separates. Further, flow separation can lead to an increase in blade noise. Flow separation depends on a number of factors, such as incoming air flow characteristics (e.g. Reynolds number, wind speed, in-flow atmospheric turbulence), characteristics of the blade (e.g. airfoil sections, blade chord and thickness, twist distribution, etc.), and operational characteristics (such as pitch angle, rotor speed, etc.).

For some wind turbines, a rise in noise at lower wind speeds has been observed. For example, increases in the noise at low wind speeds have been attributed to dramatic reductions in the blade chord and thickness of the rotor blade in the outboard region.

As such, the industry is continuously seeking improved rotor blades that address the aforementioned issues.

### BRIEF DESCRIPTION

Aspects and advantages of the invention will be set forth in part in the following description, or may be obvious from the description, or may be learned through practice of the invention.

In one aspect, the present disclosure is directed to a rotor blade assembly of a wind turbine. The rotor blade assembly includes an aerodynamic body having an inboard region and an outboard region. The inboard and outboard regions define a pressure side, a suction side, a leading edge, and a trailing edge. The inboard region includes a blade root, whereas the outboard region includes a blade tip. The outboard region also has a twist variation of less than plus or minus about 0.5 degrees (°) in order to reduce a rate of reduction in at least one of a chord length or a thickness of the rotor blade in the outboard region.

In one embodiment, the twist variation may be less than plus or minus about 0.4°. More specifically, in certain embodiments, the twist variation may be less than plus or minus about 0.35°. In another embodiment, an overall twist variation from the blade root to the blade tip of the rotor blade is less than about 12°.

In further embodiments, the rate of reduction in the chord length and/or the thickness of the rotor blade in the outboard region may range from about 20% per 10% span to about 25% per 10% span.

In additional embodiments, the outboard region of the rotor blade may range from about 0% to about 50% of the blade span from the blade tip of the rotor blade in a span-wise direction. More specifically, in particular embodiments, the outboard region may range from about 0% to about 50% of the blade span from the blade tip of the rotor blade in the span-wise direction and more preferably from about 8% to about 40% of the blade span from the blade tip of the rotor blade in a span-wise direction.

In another aspect, the present disclosure is directed to a method for mitigating noise generated by a rotor blade of a wind turbine during low wind speed conditions. The method includes providing the rotor blade having an aerodynamic body with an inboard region and an outboard region. The inboard and outboard regions define a pressure side, a suction side, a leading edge, and a trailing edge. The inboard region has a blade root, whereas the outboard region has a blade tip. The method also includes providing a twist variation in the outboard region of the rotor blade of less than plus or minus about 0.5 degrees (°) in order to reduce a rate of reduction in at least one of a chord length or a thickness of the rotor blade in the outboard region. It should be understood that the method may include any of the steps and/or features described herein.

In yet another aspect, the present disclosure is directed to a rotor blade assembly of a wind turbine. The rotor blade assembly includes an aerodynamic body having an inboard region and an outboard region. The inboard and outboard regions define a pressure side, a suction side, a leading edge, and a trailing edge. The inboard region includes a blade root, whereas the outboard region includes a blade tip. The outboard region also has a rate of reduction in at least one of a chord length or a thickness of the rotor blade ranging from about 20% per 10% span to about 25% per 10% span. It should be understood that the rotor blade assembly may include any of the features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine according to the present disclosure;

FIG. 2 illustrates a perspective view of one embodiment of a rotor blade of a wind turbine according to the present disclosure;

FIG. 3 illustrates a cross-sectional view of the rotor blade of FIG. 2 along line 3-3;

FIG. 4 illustrates a cross-sectional view of the rotor blade of FIG. 2 along line 4-4, particularly illustrating a reduced chord length and a reduced blade thickness in the outboard region of the rotor blade;

FIG. 5 illustrates a graph of one embodiment of the twist distribution/variation of the rotor blade according to the present disclosure compared to conventional rotor blades in degrees (y-axis) versus the r/Radius (x-axis) or normalized rotor radius;

FIG. 6 illustrates a graph of one embodiment of the blade thickness (y-axis) of the rotor blade according to the present disclosure compared to conventional rotor blades in millimeters versus the r/Radius (x-axis) or normalized rotor radius; and

FIG. 7 illustrates a flow diagram of one embodiment of a method for manufacturing a rotor blade of a wind turbine to mitigate noise during low wind speed conditions according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

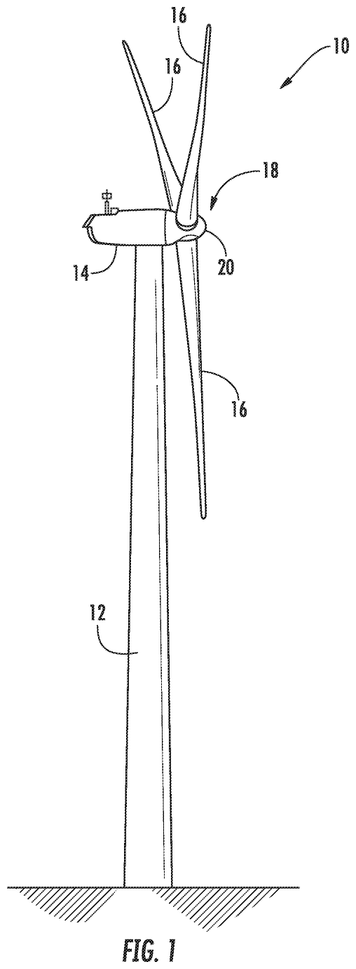

Referring now to the drawings, FIG. 1 illustrates a wind turbine 10 according to the present disclosure. As shown, the wind turbine 10 includes a tower 12 with a nacelle 14 mounted thereon. The wind turbine 10 also includes a rotor hub 18 having a rotatable hub 20 with a plurality of rotor blades 16 mounted thereto, which is in turn connected to a main flange that turns a main rotor shaft (not shown). Further, the wind turbine power generation and control components are typically housed within the nacelle 14. The view of FIG. 1 is provided for illustrative purposes only to place the present invention in an exemplary field of use. It should be appreciated that the invention is not limited to any particular type of wind turbine configuration.

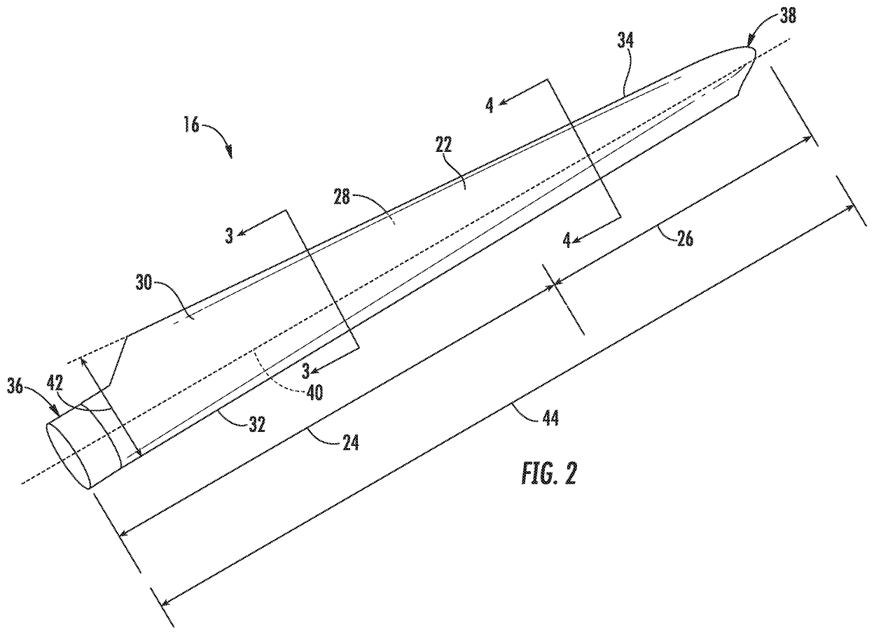

Referring now to FIG. 2, a perspective view of one of the rotor blades 16 of the wind turbine 10 of FIG. 1 according to the present disclosure is illustrated. More specifically, as shown, the rotor blade 16 includes one or more features configured to reduce noise associated with high wind speed conditions. As shown, the rotor blade 16 includes an aerodynamic body 22 having an inboard region 24 and an outboard region 26. Further, the inboard and outboard regions 24, 26 define a pressure side 28 and a suction side 30 extending between a leading edge 32 and a trailing edge 34. Further, the inboard region 24 includes a blade root 36, whereas the outboard region 26 includes a blade tip 38.

Moreover, as shown, the rotor blade 16 defines a pitch axis 40 relative to the rotor hub 18 (FIG. 1) that typically extends perpendicularly to the rotor hub 18 and the blade root 36 through the center of the blade root 36. A pitch angle or blade pitch of the rotor blade 16, i.e., an angle that determines a perspective of the rotor blade 16 with respect to the air flow past the wind turbine 10, may be defined by rotation of the rotor blade 16 about the pitch axis 40. In addition, the rotor blade 16 further defines a chord 42 and a span 44. More specifically, as shown in FIG. 2, the chord 42 may vary throughout the span 44 of the rotor blade 16. Thus, a local chord may be defined for the rotor blade 16 at any point on the blade 16 along the span 44.

In certain embodiments, the inboard region 24 may include from about 0% to about 50% of the span 44 of the rotor blade 16 from the blade root 36, whereas the outboard region 26 may include from about 0% to about 50% of the span 44 of the rotor blade 16 from the blade tip 38. In particular embodiments, the outboard region 26 of the rotor blade 16 may range from about 0% to about 40% of the span 44 from the blade tip 38 of the rotor blade 16 in a span-wise direction. For example, in one embodiment, the outboard region 26 may range from about 8% to about 40% of the span 44 from the blade tip 38 of the rotor blade 16 in a span-wise direction. Further, in certain embodiments, the outboard region 26 of the rotor blade 16 of the present disclosure may have a twist variation of less than plus or minus about 0.5 degrees (0) in order to reduce a rate of reduction in a chord length or a blade thickness of the rotor blade 16 in the outboard region 26. For example, in one embodiment, the twist variation in the outboard region 26 may be less than plus or minus about 0.4°. More specifically, in particular embodiments, the twist variation in the outboard region 26 may be less than plus or minus about 0.35°. Accordingly, in such embodiments, an overall twist variation for the entire rotor blade 16 from the blade root 36 to the blade tip 38 may be less than about 12°. More specifically, in one embodiment, the overall twist variation for the entire rotor blade 16 from the blade root 36 to the blade tip 38 may be less than about 11.5°, thereby making the rotor blade 16 easier to manufacture (due to less mold complexity), transport, and/or handle. As used herein, terms of degree (such as “about,” “substantially,” etc.) are understood to include a +/−10% variation.

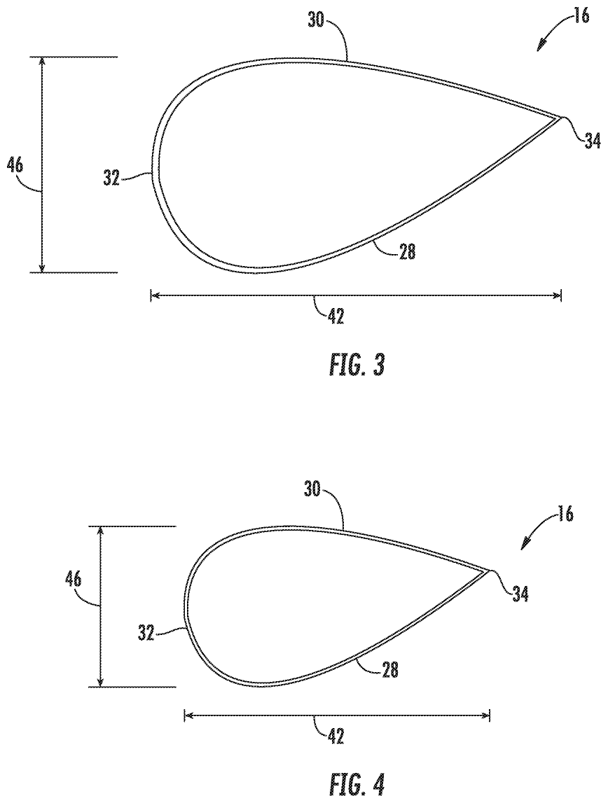

Referring now to FIGS. 3 and 4, cross-sectional views of the rotor blade 16 of FIG. 2 are illustrated along lines 3-3 and 4-4, respectively. More particularly, the reduction in the chord length 42 and the blade thickness 46 between the two different cross-sectional views is illustrated. In several embodiments, the rate of reduction in the chord length 42 and/or the thickness 46 of the rotor blade 16 in the outboard region 26 may range from about 20% per 10% span to about 25% per 10% span.

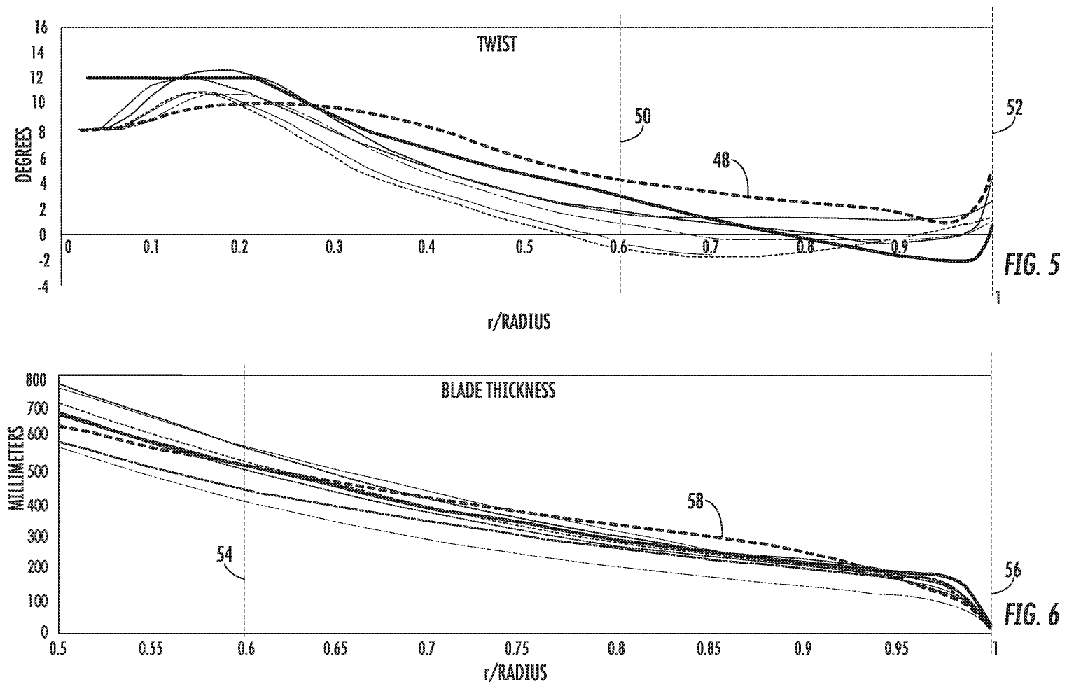

Referring now to FIGS. 5 and 6, various graphs illustrating certain characteristics (such as the twist and blade thickness) of one embodiment of a rotor blade assembly according to the present disclosure are illustrated. More particularly, FIG. 5 illustrates a graph of one embodiment of the twist distribution/variation 48 of the rotor blade 16 according to the present disclosure compared to conventional rotor blades in degrees (y-axis) versus the r/Radius (x-axis) or normalized rotor radius. FIG. 6 illustrates a graph of one embodiment of the blade thickness 58 (y-axis) of the rotor blade 16 according to the present disclosure compared to conventional rotor blades in millimeters versus the r/Radius (x-axis) or normalized rotor radius according to the present disclosure. More specifically, as shown in FIG. 5, the variation in the twist 48 in the outboard region 26 (i.e. from about 0.6 to about 1 r/Radius (as indicated by dotted vertical lines 50 and 52)) for the rotor blade 16 is less than about 8° (e.g. between about −2° to about 6°). Further, as shown in FIG. 6, the rate of reduction of the blade thickness 58 (in millimeters) in the outboard region 26 (i.e. from about 0.6 to about 1 r/Radius (as indicated by dotted vertical lines 54 and 56)) for the rotor blade 16 is less than about 20% per 10% span (e.g. from 0.6 to 0.7 span) to about 25% per 10% span.

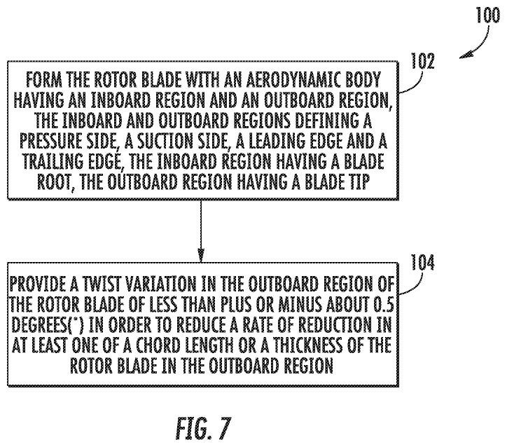

Referring now to FIG. 7, a flow diagram of one embodiment of one embodiment of a method 100 for manufacturing a rotor blade of a wind turbine to mitigate noise during low wind speed conditions is illustrated. In general, the method 100 will be described herein with reference to the wind turbine 10 and rotor blade 16 shown in FIGS. 1 and 2. However, it should be appreciated that the disclosed method 100 may be implemented with wind turbines having any other suitable configurations. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (102), the method 100 may include providing the rotor blade 16 having an aerodynamic body 22 with an inboard region 24 and an outboard region 26. Further, as mentioned, the inboard and outboard regions 24, 26 define a pressure side 28, a suction side 30, a leading edge 32, and a trailing edge 34. Moreover, the inboard region 24 includes the blade root 36, whereas the outboard region 26 includes the blade tip 38. As shown at (104), the method 100 may include providing a twist variation in the outboard region 26 of the rotor blade 16 of less than plus or minus about 0.5 degrees (°) in order to reduce a rate of reduction in the chord length 42 and/or the thickness 46 of the rotor blade 16 in the outboard region 26.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly of a wind turbine, the rotor blade assembly comprising:
an aerodynamic body having an inboard region and an outboard region, the inboard and outboard regions defining a pressure side, a suction side, a leading edge, and a trailing edge, the inboard region comprising a blade root, the outboard region comprising a blade tip,
the outboard region comprising a twist variation of less than plus or minus about 0.5 degrees (°) in order to reduce a rate of reduction in at least one of a chord length or a thickness of the rotor blade in the outboard region.

2. The rotor blade assembly of claim 1, wherein the twist variation is less than plus or minus about 0.4°.

3. The rotor blade assembly of claim 2, wherein the twist variation is less than plus or minus about 0.35°.

4. The rotor blade assembly of claim 1, wherein an overall twist variation from the blade root to the blade tip of the rotor blade is less than about 12°.

5. The rotor blade assembly of claim 1, wherein the rate of reduction in at least one of the chord length or the thickness of the rotor blade in the outboard region ranges from about 20% per 10% span to about 25% per 10% span.

6. The rotor blade assembly of claim 1, wherein the outboard region of the rotor blade comprises from about 0% to about 50% of blade span from the blade tip of the rotor blade in a span-wise direction.

7. The rotor blade assembly of claim 6, wherein the outboard region comprises from about 8% to about 40% of blade span from the blade tip of the rotor blade in a span-wise direction.

8. A method for manufacturing a rotor blade of a wind turbine to mitigate noise during low wind speed conditions, the method comprising:
forming the rotor blade with an aerodynamic body having an inboard region and an outboard region, the inboard and outboard regions defining a pressure side, a suction side, a leading edge, and a trailing edge, the inboard region having a blade root, the outboard region having a blade tip; and,
providing a twist variation in the outboard region of the rotor blade of less than plus or minus about 0.5 degrees (°) in order to reduce a rate of reduction in at least one of a chord length or a thickness of the rotor blade in the outboard region.

9. The method of claim 8, wherein the twist variation is less than plus or minus about 0.4°.

10. The method of claim 9, wherein the twist variation is less than plus or minus about 0.35°.

11. The method of claim 8, further comprising providing an overall twist variation from the blade root to the blade tip of the rotor blade of less than about 12°.

12. The method of claim 8, wherein the rate of reduction in at least one of the chord length or the thickness of the rotor blade in the outboard region ranges from about 20% per 10% span to about 25% per 10% span.

13. The method of claim 8, wherein the outboard region of the rotor blade comprises from about 0% to about 50% of blade span from the blade tip of the rotor blade in a span-wise direction.

14. The method of claim 13, wherein the outboard region of the rotor blade comprises from about 8% to about 40% from the blade tip of the rotor blade in a span-wise direction.

15. A rotor blade assembly of a wind turbine, the rotor blade assembly comprising:
an aerodynamic body having an inboard region and an outboard region, the inboard and outboard regions defining a pressure side, a suction side, a leading edge, and a trailing edge, the inboard region comprising a blade root, the outboard region comprising a blade tip,
the outboard region comprising a rate of reduction in at least one of a chord length or a thickness of the rotor blade ranging from about 20% per 10% span to about 25% per 10% span.

16. The rotor blade assembly of claim 15, wherein the outboard region comprises a twist variation of less than plus or minus about 0.5 degrees (°).

17. The rotor blade assembly of claim 16, wherein the twist variation is less than plus or minus about 0.35°.

18. The rotor blade assembly of claim 15, wherein an overall twist variation from the blade root to the blade tip is less than about 12°.

19. The rotor blade assembly of claim 15, wherein the outboard region comprises from about 0% to about 50% of blade span from the blade tip of the rotor blade in a span-wise direction.

20. The rotor blade assembly of claim 19, wherein the outboard region comprises from about 8% to about 40% from the blade tip of the rotor blade in a span-wise direction.
